(19) United States
(12) Patent Application Publication
(10) Pub. No.: US 2018/0290661 A1
(43) Pub. Date: Oct. 11, 2018

(54) CAR CONTROL METHOD AND OPERATING METHOD THEREOF

(71) Applicant: Primax Electronics Ltd., Taipei (TW)

(72) Inventor: Tsung-Yi LU, Taipei (TW)

(21) Appl. No.: 15/705,928

(22) Filed: Sep. 15, 2017

(30) Foreign Application Priority Data
Apr. 7, 2017 (TW) 106111734

(51) Int. Cl. B60W 40/08; G05B 15/02

(52) U.S. Cl. CPC B60W 40/08; G05B 15/02; B60W 2900/00; B60W 2540/28; B60W 2040/0809

(57) ABSTRACT

A car control device is used for a car. The car control device includes a microcontroller unit, a display module, a pressure sensing unit, a wireless transmission module, a fingerprint identification module and a memory unit. A control signal is transmitted from the car control device to the car through the wireless transmission module. The fingerprint identification module acquires a fingerprint information of a user. The microcontroller unit compares the fingerprint information with the fingerprint record of the memory unit and executes a mental condition test program to perform a mental condition test on the user. If the microcontroller unit judges that the fingerprint information is correct and the user passes the mental condition test, the microcontroller unit issues the control signal to the car through the wireless transmission module so as to control the car.

### FIELD OF THE INVENTION

The present invention relates to a field of a remote controller, and more particularly to a car control device and an operating method thereof.

### BACKGROUND OF THE INVENTION

A car is one of the very popular transportation devices in the modern society. Generally, each car is equipped with a dedicated remote control key. The owner of the car can operate the remote control key to control the car in order to lock/unlock the car door or start the car.

Although the use of the remote control key is very easy, there are still some drawbacks. For example, if the remote control key is lost and picked up by a person with bad intentions, the person can easily open the car door in a wireless remote control manner. That is, the convenience of the remote control key indicates that the risk of losing the car increases. For reducing the possibility of losing the car, some technologies have been disclosed. For example, the car is equipped with an anti-start system. In the anti-start system, a chip is installed in a mechanical key of the car. After the mechanical key is inserted into a keyhole of the car and the password from the chip of the mechanical key complies with a predetermined password of a chip inside a casing of the keyhole, the car can be ignited and started. Moreover, a touch control car key with a fingerprint unlocking function is disclosed in China Patent Publication No. CN205604869U. The touch control car key comprises a fingerprint identification module, a controller, a switching circuit, a power source and a touch display module. If the fingerprint message captured by the fingerprint identification module complies with a predetermined password message, the switching circuit is closed under control of the controller. Consequently, the power source provides electric power to the touch display module. Meanwhile, the user may operate the touch display module to lock/unlock the car door or start the car.

The current technology is effective to reduce the possibility of losing the car. However, there are still some drawbacks. For example, if the mental condition or the body condition of the user is not suitable for driving the car, the remote control key is still able to open the car door and start the car. In other words, the current technology cannot increase the driving safety.

Therefore, there is a need of providing a car control device and an operating method of the car control device in order to reduce the possibility of losing the car and enhance the safety of driving the car.

### SUMMARY OF THE INVENTION

The present invention provides a car control device and an operating method of the car control device in order to reduce the possibility of losing the car and enhance the safety of driving the car.

In accordance with an aspect of the present invention, there is provided a car control device for controlling a car. The car control device includes a microcontroller unit, a display module, a pressure sensing unit, a wireless transmission module, a fingerprint identification module and a memory unit. A control signal is transmitted from the car control device to the car through the wireless transmission module. The fingerprint identification module acquires a fingerprint information of a user. The memory unit stores a fingerprint database and a mental condition test program. The fingerprint database includes at least one user name and a fingerprint record corresponding to the at least one user name. If the microcontroller unit judges that the fingerprint information complies with the fingerprint record according to a result of comparing the fingerprint information with the fingerprint record, the microcontroller unit executes the mental condition test program and the display module shows a mental condition test interface. When the user operates the pressure sensing unit to perform a mental condition test on the mental condition test interface, the microcontroller unit judges whether the user passes the mental condition test. If the microcontroller unit judges that the user passes the mental condition test, the microcontroller unit issues the control signal to the car through the wireless transmission module so as to control the car.

In an embodiment, if the microcontroller unit judges that the user passes the mental condition test, the microcontroller unit issues the control signal to the car through the wireless transmission module so as to unlock the car.

In an embodiment, if the microcontroller unit judges that the user passes the mental condition test, the microcontroller unit issues the control signal to the car through the wireless transmission module so as to start the car.

In an embodiment, if the microcontroller unit judges that the fingerprint information complies with the fingerprint record, the microcontroller unit issues the control signal to the car through the wireless transmission module so as to unlock the car.

In an embodiment, the memory unit further stores a scenario control program, and the scenario control program contains a scenario parameter corresponding to the at least one user name. When the microcontroller unit executes the scenario control program, the scenario parameter is transmitted from the microcontroller unit to the car through the wireless transmission module, and a built-in device of the car is adjusted according to the scenario parameter.

In an embodiment, if the microcontroller unit judges that the fingerprint information complies with the fingerprint record, the scenario parameter is transmitted from the microcontroller unit to the car.

In an embodiment, if the microcontroller unit judges that the user passes the mental condition test, the scenario parameter is transmitted from the microcontroller unit to the car.

In an embodiment, the built-in device is a navigation device, a driving recorder, a dashboard, a media player, a seat, an air conditioner, a lighting device or a rearview mirror.

In an embodiment, the pressure sensing unit is a capacitive pressure sensor, a piezoelectric pressure sensor or a piezo-resistive pressure sensor.

In an embodiment, the wireless transmission module is an infrared transmission module or a radio transmission module.

In an embodiment, the fingerprint identification module is an optical fingerprint identification module, a capacitive fingerprint identification module or an ultrasonic fingerprint identification module.

In an embodiment, the car control device further includes a power module, and the power module includes a power supply, a voltage regulating unit and a switch element.

In an embodiment, the power supply is a carbon-zinc battery, an alkaline battery, a nickel-metal hydride battery, a nickel-cadmium battery or a lithium battery.

In an embodiment, the voltage stabilizing unit is a low dropout voltage regulator.

In accordance with another aspect of the present invention, there is provided an operating method of a car control device for controlling a car. The operating method includes the following steps. In a step (a), a fingerprint information of a user is acquired. Then, a step (b) is performed to judge whether the fingerprint information complies with the fingerprint record according to a result of comparing the fingerprint information with the fingerprint record. If the fingerprint information does not comply with the fingerprint record, a first warning mode is enabled. If the fingerprint information complies with the fingerprint record, a next step is performed. Then, a step (c) is performed to judge whether the user passes a mental condition test. If the user does not pass the mental condition test, a second warning mode is enabled. If the user passes the mental condition test, a next step is performed. In a step (d), the car is started.

In an embodiment, if the fingerprint information complies with the fingerprint record in the step (b), the car is unlocked.

In an embodiment, if the fingerprint information complies with the fingerprint record in the step (b), a built-in device of the car is adjusted according to a preference of the user.

In an embodiment, if the user passes the mental condition test in the step (c), a built-in device of the car is adjusted according to a preference of the user.

In an embodiment, after the car is started in the step (d), a built-in device of the car is adjusted according to a preference of the user.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic block diagram illustrating the architecture of a car control device according to an embodiment of the present invention;

FIG. 2A is a flowchart of an operating method of a car control device according to a first embodiment of the present invention;

FIG. 2B is a flowchart of an operating method of a car control device according to a second embodiment of the present invention;

FIG. 3 is a schematic view of the car control device according to the embodiment of the present invention; and

FIGS. 4A-4E schematically illustrate the steps of performing the mental condition test by using the car control device of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

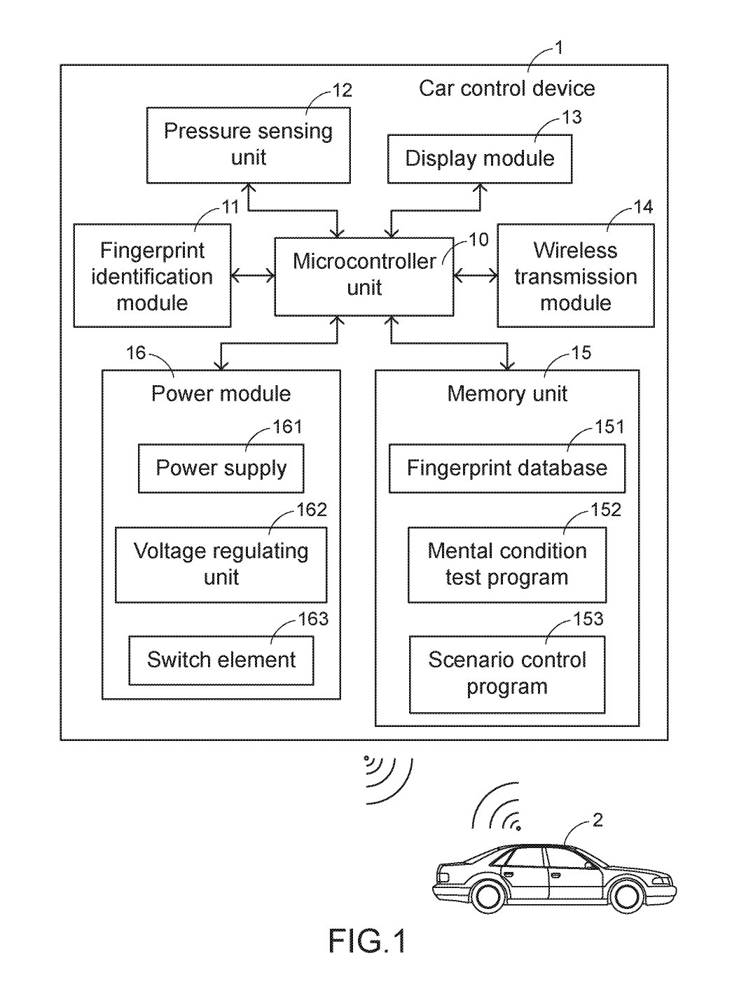

FIG. 1 is a schematic block diagram illustrating the architecture of a car control device according to an embodiment of the present invention. The car control device 1 as shown in FIG. 1 is used for transmitting a control signal to a central control system (not shown) of a car 2 in order to control the car 2. For example, the central control system of the car 2 is a keyless start system or a general mechanical key start system. In this embodiment, the car control device 1 comprises a microcontroller unit 10, a fingerprint identification module 11, a pressure sensing unit 12, a display module 13, a wireless transmission module 14, a memory unit 15 and a power module 16. The microcontroller unit 10 issues a control signal to the central control system of a car 2. According to the control signal, the car 2 performs a corresponding control operation. An example of the wireless transmission module 14 includes but is not limited to an infrared transmission module or a radio transmission module.

The power module 16 is used for providing electric power to power the car control device 1. In an embodiment, the power module 16 comprises a power supply 161, a voltage regulating unit 162 and a switch element 163. An example of the power supply 161 includes but is not limited to a carbon-zinc battery, an alkaline battery, a nickel-metal hydride battery, a nickel-cadmium battery or a lithium battery. The voltage stabilizing unit 162 is a low dropout voltage regulator (LDO). By the low dropout voltage regulator, the power module 16 provides a stable DC voltage to power the car control device 1. The car control device 1 is turned on or turned off through the switch element 163.

The fingerprint identification module 11 is used for acquiring the fingerprint information of the user. For example, the fingerprint identification module 11 is an optical fingerprint identification module, a capacitive fingerprint identification module or an ultrasonic fingerprint identification module. The memory unit 15 stores a fingerprint database 151, a mental condition test program 152 and a scenario control program 153. When the car control device 1 is used for the first time, the fingerprint information of the user is captured by the fingerprint identification module 11. Moreover, the acquired fingerprint information is stored in the fingerprint database 151. When the acquired fingerprint information is stored in the fingerprint database 151, a dedicated user name corresponding to the user is created in the fingerprint database 151. Then, the acquired fingerprint information of the user is stored as a fingerprint record corresponding to the user name. In an embodiment, the user name is default number of the fingerprint database 151. For example, the user name is A001, A002, A003, . . . , or the like. Alternatively, the user name is defined by the user. For example, the English name or representative symbol of the user may be set as the user name. In another embodiment, one user name or plural user names are stored in the fingerprint database 151. Moreover, each user name corresponds to a single fingerprint record or plural fingerprint records. For example, the plural fingerprint records include the fingerprint of the user's left thumb, the fingerprint of the user's right thumb, and so on. The scenario control program 153 is executed to set and store scenario parameters corresponding to the user names. The scenario parameters are transmitted from the microcontroller unit 10 to the central control system of the car 2 through the wireless transmission module 14. According to the scenario parameters, at least one built-in device (not shown) of the car 2 is controlled or adjusted. For example, the built-in device includes a navigation device, a driving recorder, a dashboard, a media player, a seat, an air conditioner, a lighting device or a rearview mirror. When the dedicated user name corresponding to the user is created, the scenario parameters are set through the scenario control program 153 according to the preference or the driving habit of the user.

For example, the central control system of the car 2 is a keyless start system. When the car control device 1 is used to control or start the car 2 again, the following procedures are performed. For example, the fingerprint identification module 11 captures the fingerprint information of the user. Then, the microcontroller unit 10 compares the captured fingerprint information with the fingerprint record, which is previously stored in the fingerprint database 151. If the captured fingerprint information does not comply with the fingerprint record of the fingerprint database 151, the microcontroller unit 10 enables a first warning mode. In the first warning mode, the display module 13 displays a warning message, a built-in speaker unit (not shown) of the display module 13 generates a warning sound, or a built-in vibration unit (not shown) of the display module 13 generates a warning vibration message. The warning message, the warning sound or the warning vibration message prompts the user to capture the fingerprint information again. Moreover, if the number of times the first warning mode is repeatedly enabled exceeds a predetermined value (e.g., 10), the microcontroller unit 10 will automatically turn off the car control device 1. Under this circumstance, the user cannot operate the switch element 163 to turn on the car control device 1 within a predetermined time period (e.g., 20˜60 minutes). Consequently, even if the car control device 1 is lost, the risk of losing the car 2 through steal will be largely reduced. An example of the display module 13 includes but is not limited to a liquid crystal display (LCD) or an electronic paper display (EPD).

Please refer to FIG. 1 again. If the captured fingerprint information complies with the fingerprint record of the fingerprint database 151, the microcontroller unit 10 issues a control signal to the car 2 through the wireless transmission module 14. According to the control signal, the car 2 is unlocked. Consequently, the user can open the door of the car 2 and enter the car 2. Meanwhile, the car 2 cannot be started. Moreover, the scenario control program 153 is executed by the microcontroller unit 10, and the scenario parameter corresponding to the user name of the user is transmitted from the microcontroller unit 10 to the central control system of the car 2 through the wireless transmission module 14. According to the scenario parameter, the built-in device of the car 2 is adjusted by the central control system of the car 2. For example, according to the scenario parameter, the central control system of the car 2 loads the preset destination coordinate or the frequently-visited location coordinate of the user into the navigation device. Alternatively, according to the scenario parameter, the central control system of the car 2 turns on/off the driving recorder or adjusting the recording time of the driving recorder. Alternatively, according to the scenario parameter, the central control system of the car 2 adjusts the display mode or the display information of the dashboard. Alternatively, according to the scenario parameter, the central control system of the car 2 loads a user's preferred media list or playing mode (e.g., sound volume, playing sequence or random playing) into the media player. Alternatively, according to the scenario parameter, the central control system of the car 2 adjusts the seat to have the position of the seat or the tilt angle of the seat match the user's height or the driving habit of the user. Alternatively, according to the scenario parameter, the central control system of the car 2 adjusts the environment condition within the car through the air conditioner to have the temperature or humidity within the car match the user's preference. Alternatively, according to the scenario parameter, the central control system of the car 2 adjusts the environment condition within the car through the lighting device to have the brightness or the color temperature within the car match the user's preference. Alternatively, according to the scenario parameter, the central control system of the car 2 adjusts the monitoring angle of the rearview mirror to match the viewing angle of the user or the driving habit of the user. When the car 2 is used by a different user, the built-in device of the car 2 is adjusted according to the corresponding scenario parameter. In other words, the built-in device of the car 2 can meet the requirements of different users.

Please refer to FIG. 1 again. After the microcontroller unit 10 judges that the captured fingerprint information complies with the fingerprint record of the fingerprint database 151, the microcontroller unit 10 executes the mental condition test program 152 of the memory unit 15 and the display module 13 shows a mental condition test interface. Meanwhile, the user operates the pressure sensing unit 12 to perform a mental condition test on the mental condition test interface. Then, the microcontroller unit 10 judges whether the user passes a mental condition test. If the user does not pass the mental condition test, the microcontroller unit 10 enables a second warning mode. In the second warning mode, the display module 13 displays a warning message, the built-in speaker unit of the display module 13 generates a warning sound, or the built-in vibration unit of the display module 13 generates a warning vibration message. The warning message, the warning sound or the warning vibration message prompts the user that the mental condition of the user is not suitable for driving the car. Meanwhile, the car 2 still cannot be started. In an embodiment, the central control system of the car 2 is equipped with an emergency assistance (EA) system. In the second warning mode, the EA system controls the central control system of the car 2 to automatically dial or issue a message to the emergency contact person of the user so as to notify the emergency contact person that the user of the car 2 needs help.

Please refer to FIG. 1 again. If the microcontroller unit 10 judges that the user passes the mental condition test, the microcontroller unit 10 issues the control signal to the car 2 through the wireless transmission module 14 so as to start the car 2. In case that the central control system of the car 2 is a mechanical key start system, the microcontroller unit 10 judges whether the captured fingerprint information complies with the fingerprint record of the fingerprint database 151 and whether the user passes the mental condition test. If the two judging conditions are satisfied, the microcontroller unit 10 issues the control signal to the car 2 through the wireless transmission module 14 so as to unlock the car 2. Meanwhile, the user can open the door of the car 2, enter the car 2 and use the mechanical key to start the car 2.

As mentioned above, the scenario control program 153 is executed when the microcontroller unit 10 judges that the fingerprint information complies with the fingerprint record of the fingerprint database 151. In some embodiments, the scenario control program 153 is executed at different time points according to the user's preference or requirement. For example, if the microcontroller unit 10 judges that the user passes the mental condition test or the microcontroller unit 10 judges that the car 2 is started, the scenario control program 153 is executed. Moreover, the scenario parameter corresponding to the user name is transmitted from the microcontroller unit 10 to the central control system of the car 2 through the wireless transmission module 14. According to the scenario parameter corresponding to the user name, the built-in device of the car 2 is adjusted by the central control system of the car 2.

In the above embodiment, the scenario control program 153 is installed in the car control device 1. It is noted that numerous modifications and alterations may be made while retaining the teachings of the invention. For example, in another embodiment, the scenario control program 153 is installed in the central control system of the car 2. The dedicated user name corresponding to the user is transmitted from the car control device 1 to the central control system of the car 2. Then, the scenario control program 153 is executed by the central control system of the car 2. According to the scenario parameter corresponding to the user name, the built-in device of the car 2 is adjusted. That is, the scenario control program 153 is not restrainedly installed in the car control device 1.

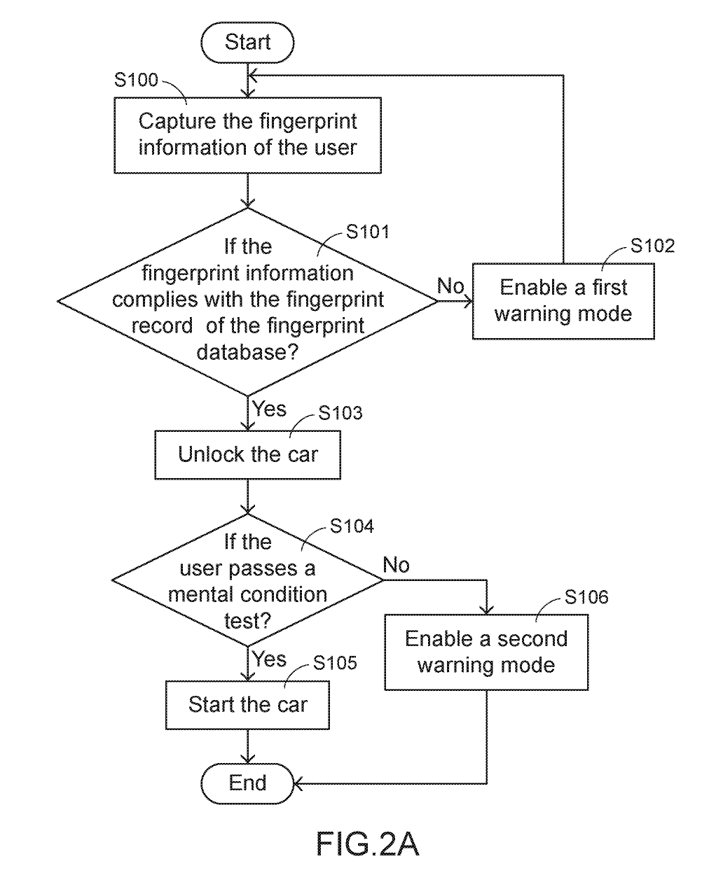

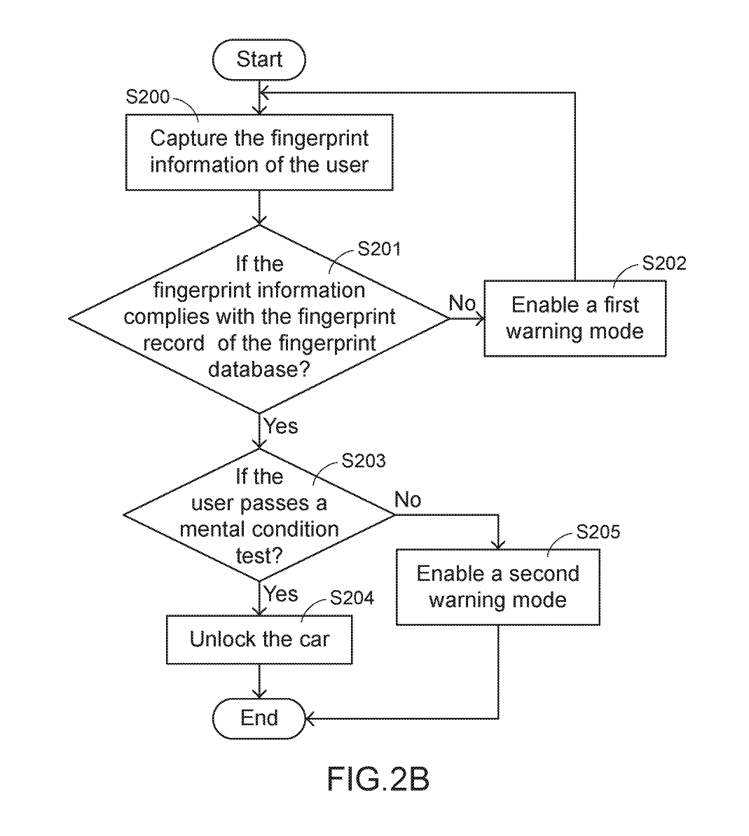

Please refer to FIGS. 1 and 2A. FIG. 2A is a flowchart of an operating method of a car control device according to a first embodiment of the present invention. The operating method of this embodiment is applied to the car with the keyless start system. Firstly, the fingerprint identification module 11 captures the fingerprint information of the user (Step S100). Then, the microcontroller unit 10 judges whether the fingerprint information complies with the fingerprint record of the fingerprint database 151 according to the result of comparing the fingerprint information with the fingerprint record (Step S101). If the judging condition of the step S101 is not satisfied, the microcontroller unit 10 enables a first warning mode (Step S102). In the first warning mode, the display module 13 displays a warning message, a built-in speaker unit of the display module 13 generates a warning sound, or a built-in vibration unit of the display module 13 generates a warning vibration message. The warning message, the warning sound or the warning vibration message prompts the user to capture the fingerprint information again. Moreover, if the number of times the first warning mode is repeatedly enabled exceeds a predetermined value (e.g., 10), the microcontroller unit 10 will automatically turn off the car control device 1. Under this circumstance, the user cannot operate the switch element 163 to turn on the car control device 1 within a predetermined time period (e.g., 20˜60 minutes). If the judging condition of the step S101 is satisfied, the car 2 is unlocked (Step S103). In the step S103, the microcontroller unit 10 issues a control signal to the car 2 through the wireless transmission module 14. According to the control signal, the car 2 is unlocked. Consequently, the user can open the door of the car 2 and enter the car 2. Meanwhile, the car 2 cannot be started.

Then, the microcontroller unit 10 judges whether the user passes a mental condition test (Step S104). In the step S104, the microcontroller unit 10 executes the mental condition test program 152 of the memory unit 15 and the display module 13 shows a mental condition test interface. Meanwhile, the user operates the pressure sensing unit 12 to perform a mental condition test on the mental condition test interface. If the judging condition of the step S104 is not satisfied, the microcontroller unit 10 enables a second warning mode (Step S106). In the second warning mode, the display module 13 displays a warning message, the built-in speaker unit of the display module 13 generates a warning sound, or the built-in vibration unit of the display module 13 generates a warning vibration message. The warning message, the warning sound or the warning vibration message prompts the user that the mental condition of the user is not suitable for driving the car. Meanwhile, the car 2 still cannot be started. In an embodiment, the central control system of the car 2 is equipped with an emergency assistance (EA) system. In the second warning mode, the EA system controls the central control system of the car 2 to automatically dial or issue a message to the emergency contact person of the user so as to notify the emergency contact person that the user of the car 2 needs help. If the judging condition of the step S104 is satisfied, the car 2 is started (Step S105). In the step S105, the microcontroller unit 10 issues the control signal to the car 2 through the wireless transmission module 14 so as to start the car 2.

Moreover, if the judging condition of the step S101 or the judging condition of the step S104 is satisfied, the microcontroller unit 10 executes the scenario control program 153. Alternatively, the microcontroller unit 10 executes the scenario control program 153 in the step S105. Moreover, the scenario parameter corresponding to the user name is transmitted from the microcontroller unit 10 to the central control system of the car 2 through the wireless transmission module 14. According to the scenario parameter corresponding to the user name, the built-in device of the car 2 is adjusted.

Please refer to FIGS. 1 and 2B. FIG. 2B is a flowchart of an operating method of a car control device according to a second embodiment of the present invention. The operating method of this embodiment is applied to the car with the mechanical key start system. The steps S200, S201, S202, S203 and S205 of this embodiment are respectively similar to the steps S100, S101, S102, S104 and S106 of FIG. 2A. Consequently, the details of these steps are not redundantly described herein. Since the central control system of the car 2 is the mechanical key start system, the following aspect of this embodiment is distinguished from FIG. 2A. In the step S201, the microcontroller unit 10 judges whether the fingerprint information complies with the fingerprint record of the fingerprint database 151. In the step S203, the microcontroller unit 10 judges whether the user passes the mental condition test. If the judging condition of the step S201 and the judging condition of the step S203 are satisfied, the microcontroller unit 10 issues the control signal to the car 2 through the wireless transmission module 14 so as to unlock the car 2 (Step S204). Meanwhile, the user can open the door of the car 2, enter the car 2 and use the mechanical key to start the car 2.

Moreover, if the judging condition of the step S201 or the judging condition of the step S203 is satisfied, the microcontroller unit 10 executes the scenario control program 153. Alternatively, the microcontroller unit 10 executes the scenario control program 153 in the step S204. Moreover, the scenario parameter corresponding to the user name is transmitted from the microcontroller unit 10 to the central control system of the car 2 through the wireless transmission module 14. According to the scenario parameter corresponding to the user name, the built-in device of the car 2 is adjusted.

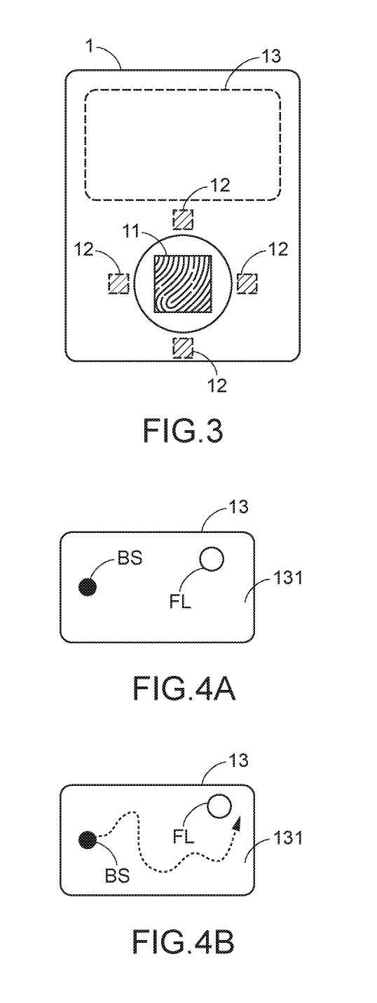

FIG. 3 is a schematic view of the car control device according to the embodiment of the present invention. As shown in FIG. 3, the car control device 1 comprises a display module 13, a fingerprint identification module 11 and four pressure sensing units 12. The four pressure sensing units 12 are located at four sides of the fingerprint identification module 11. It is noted that the arrangement of the pressure sensing units 12 may be varied according to the type and the operating method of the mental condition test program 152. For example, the car control device 1 is equipped with one pressure sensing unit 12 or plural pressure sensing units 12. Moreover, the arrangement of the pressure sensing units 12 is not limited.

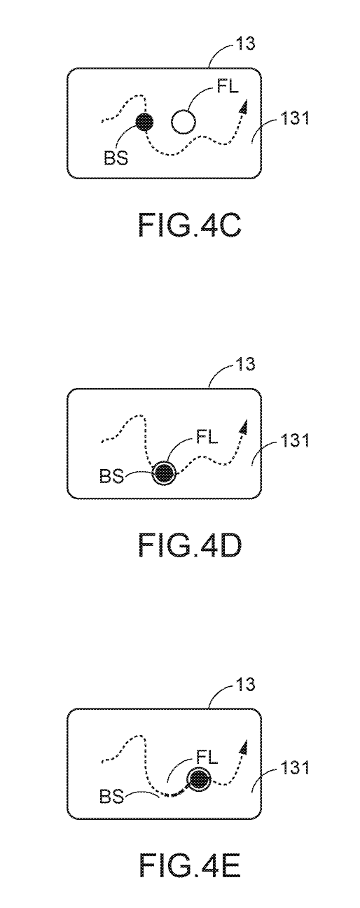

Please refer to FIG. 1, FIG. 3 and FIGS. 4A˜4E. FIGS. 4A˜4E schematically illustrate the steps of performing the mental condition test by using the car control device of the present invention.

Please refer to FIG. 4A. When the mental condition test program 152 of the memory unit 15 is executed, a mental condition test interface 131 is shown on the display module 13. In this embodiment, a circular block dot BS and a circular line FL are shown on the mental condition test interface 131.

Please refer to FIG. 4B. While the mental condition test is performed, the circular block dot BS is randomly and irregularly moved on the mental condition test interface 131. Meanwhile, the user can operate the pressure sensing units 12 to control the moving direction of the circular line FL.

Please refer to FIG. 4C. The user operates the pressure sensing units 12. Consequently, the circular line FL is moved toward the circular block dot BS.

Please refer to FIG. 4D. The user operates the pressure sensing units 12. Consequently, the circular line FL surrounds the circular block dot BS.

Please refer to FIG. 4E. The user operates the pressure sensing units 12 to have the circular line FL surround the circular block dot BS. In addition, the circular line FL is moved with the circular block dot BS. If the circular line FL is moved with the circular block dot BS in response to the user's operation, the microcontroller unit 10 judges that the user passes a mental condition test.

From the above descriptions, the present invention provides a car control device. The fingerprint identification module is used for unlocking the car. While the mental condition test program is performed, the pressure sensing unit is operated to perform the mental condition test in order to judge whether the mental condition or the body condition of the user is suitable for driving the car. Consequently, the possibility of losing the car is largely reduced, and the safety of driving the car is enhanced. In other words, the technology of the present invention is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A car control device for controlling a car, comprising:
a microcontroller unit;
a display module;
a pressure sensing unit;
a wireless transmission module, wherein a control signal is transmitted from the car control device to the car through the wireless transmission module;
a fingerprint identification module acquiring a fingerprint information of a user; and
a memory unit storing a fingerprint database and a mental condition test program, wherein the fingerprint database comprises at least one user name and a fingerprint record corresponding to the at least one user name,
wherein if the microcontroller unit judges that the fingerprint information complies with the fingerprint record according to a result of comparing the fingerprint information with the fingerprint record, the microcontroller unit executes the mental condition test program and the display module shows a mental condition test interface, wherein when the user operates the pressure sensing unit to perform a mental condition test on the mental condition test interface, the microcontroller unit judges whether the user passes the mental condition test, wherein if the microcontroller unit judges that the user passes the mental condition test, the microcontroller unit issues the control signal to the car through the wireless transmission module so as to control the car.

2. The car control device according to claim 1, wherein if the microcontroller unit judges that the user passes the mental condition test, the microcontroller unit issues the control signal to the car through the wireless transmission module so as to unlock the car.

3. The car control device according to claim 1, wherein if the microcontroller unit judges that the user passes the mental condition test, the microcontroller unit issues the control signal to the car through the wireless transmission module so as to start the car.

4. The car control device according to claim 1, wherein if the microcontroller unit judges that the fingerprint information complies with the fingerprint record, the microcontroller unit issues the control signal to the car through the wireless transmission module so as to unlock the car.

5. The car control device according to claim 1, wherein the memory unit further stores a scenario control program, and the scenario control program contains a scenario parameter corresponding to the at least one user name, wherein when the microcontroller unit executes the scenario control program, the scenario parameter is transmitted from the microcontroller unit to the car through the wireless transmission module, and a built-in device of the car is adjusted according to the scenario parameter.

6. The car control device according to claim 5, wherein if the microcontroller unit judges that the fingerprint information complies with the fingerprint record, the scenario parameter is transmitted from the microcontroller unit to the car.

7. The car control device according to claim 5, wherein if the microcontroller unit judges that the user passes the mental condition test, the scenario parameter is transmitted from the microcontroller unit to the car.

8. The car control device according to claim 5, wherein the built-in device is a navigation device, a driving recorder, a dashboard, a media player, a seat, an air conditioner, a lighting device or a rearview mirror.

9. The car control device according to claim 1, wherein the pressure sensing unit is a capacitive pressure sensor, a piezoelectric pressure sensor or a piezo-resistive pressure sensor.

10. The car control device according to claim 1, wherein the wireless transmission module is an infrared transmission module or a radio transmission module.

11. The car control device according to claim 1, wherein the fingerprint identification module is an optical fingerprint identification module, a capacitive fingerprint identification module or an ultrasonic fingerprint identification module.

12. The car control device according to claim 1, wherein the car control device further comprises a power module, and the power module comprises a power supply, a voltage regulating unit and a switch element.

13. The car control device according to claim 12, wherein the power supply is a carbon-zinc battery, an alkaline battery, a nickel-metal hydride battery, a nickel-cadmium battery or a lithium battery.

14. The car control device according to claim 12, wherein the voltage stabilizing unit is a low dropout voltage regulator.

15. An operating method of a car control device for controlling a car, the operating method comprising steps of:
(a) acquiring a fingerprint information of a user;
(b) judging whether the fingerprint information complies with the fingerprint record according to a result of comparing the fingerprint information with the fingerprint record, wherein if the fingerprint information does not comply with the fingerprint record, a first warning mode is enabled, wherein if the fingerprint information complies with the fingerprint record, a next step is performed;
(c) judging whether the user passes a mental condition test, wherein if the user does not pass the mental condition test, a second warning mode is enabled, wherein if the user passes the mental condition test, a next step is performed; and
(d) starting the car.

16. The operating method according to claim 15, wherein if the fingerprint information complies with the fingerprint record in the step (b), the car is unlocked.

17. The operating method according to claim 15, wherein if the fingerprint information complies with the fingerprint record in the step (b), a built-in device of the car is adjusted according to a preference of the user.

18. The operating method according to claim 15, wherein if the user passes the mental condition test in the step (c), a built-in device of the car is adjusted according to a preference of the user.

19. The operating method according to claim 15, wherein after the car is started in the step (d), a built-in device of the car is adjusted according to a preference of the user.
